(19) United States
(12) Patent Application Publication
(10) Pub. No.: US 2012/0247112 A1
(43) Pub. Date: Oct. 4, 2012

(54) TURBINE COMBUSTION SYSTEM COOLING SCOOP

(76) Inventors: Andrew R. Narcus, Loxahatchee, FL (US); Matthew Gent, Port St. Lucie, FL (US); Neal Therrien, Stuart, FL (US)

(21) Appl. No.: 13/241,391

(22) Filed: Sep. 23, 2011

Related U.S. Application Data
(60) Provisional application No. 61/468,678, filed on Mar. 29, 2011.

(51) Int. Cl. F02C 1/00

(52) U.S. Cl. 60/759

(57) ABSTRACT

A scoop (54) over a coolant inlet hole (48) in an outer wall (40B) of a double-walled tubular structure (40A, 40B) of a gas turbine engine component (26, 28). The scoop redirects a coolant flow (37) into the hole. The leading edge (56, 58) of the scoop has a central projection (56) or tongue that overhangs the coolant inlet hole, and a curved undercut (58) on each side of the tongue between the tongue and a generally C-shaped or generally U-shaped attachment base (53) of the scoop. A partial scoop (62) may be cooperatively positioned with the scoop (54).

This application claims benefit of the Mar. 29, 2011 filing date of U.S. patent application Ser. No. 61/468,678, which is incorporated by reference herein.

### FIELD OF THE INVENTION

This invention relates to cooling of gas turbine combustion chambers and transition ducts, and particularly to scoop-assisted impingement cooling.

### BACKGROUND OF THE INVENTION

In gas turbine engines, air is compressed at an initial stage then heated in combustion chambers. The resulting hot working gas drives a turbine that performs work, including rotating the air compressor.

In a common industrial gas turbine configuration, a number of combustion chambers may be arranged in a circular array about a shaft or axis of the gas turbine engine in a “can annular” configuration. A respective array of transition ducts connects the outflow of each combustor to the turbine entrance. Each transition duct is a generally tubular walled structure or enclosure that surrounds a hot gas path between a combustion chamber and the turbine. The walls of the combustion chambers and transition ducts are subject to high temperatures from the combusted and combusting gases. These walls are subject to low cycle fatigue, due to their position between other dynamic components, temperature cycling, and other factors. This is a major design consideration for component life cycle.

Combustion chamber walls and transition duct walls may be cooled by open or closed cooling using compressed air from the turbine compressor, by steam, or by other approaches. Various designs of channels are known for passage of cooling fluids in these walls, the interior surfaces of which may be coated with a thermal barrier coating as known in the art.

An approach to cooling a transition duct is exemplified in U.S. Pat. No. 4,719,748. A sleeve over a transition duct is configured to provide impingement jets formed by apertures in the sleeve. U.S. Pat. No. 6,494,044 describes cooling a transition duct by means of a surrounding sleeve perforated with impingement cooling holes. The cooling air enters the holes and impinges on the transition duct inner wall. Air scoops facing into the cooling flow are added to some of the impingement holes to increase the impingement jet velocity. U.S. Patent Application Publication Nos. 2009/0145099 and 2010/0000200 show related scoops for impingement cooling of transition ducts.

Notwithstanding these and other approaches, there remains a need to provide more effective cooling of combustors and transition ducts.

### BRIEF DESCRIPTION OF THE DRAWINGS

The invention is explained in the following description in view of the drawings that show:

FIG. 1 is a schematic view of a prior art gas turbine engine.

FIG. 2 is a perspective view of a prior art transition duct.

FIG. 3 is a schematic sectional view of a prior art double-walled transition duct.

FIG. 4 is perspective view of an exemplary coolant scoop per aspects of the invention.

FIG. 5 is a sectional side view of the exemplary scoop of FIG. 4.

FIG. 6 is a sectional side view of an exemplary scoop with a different hole position.

FIG. 7 is a perspective view of a transition duct in accordance with one embodiment of the invention.

FIG. 8 is a perspective view of a partial scoop.

### DETAILED DESCRIPTION OF THE INVENTION

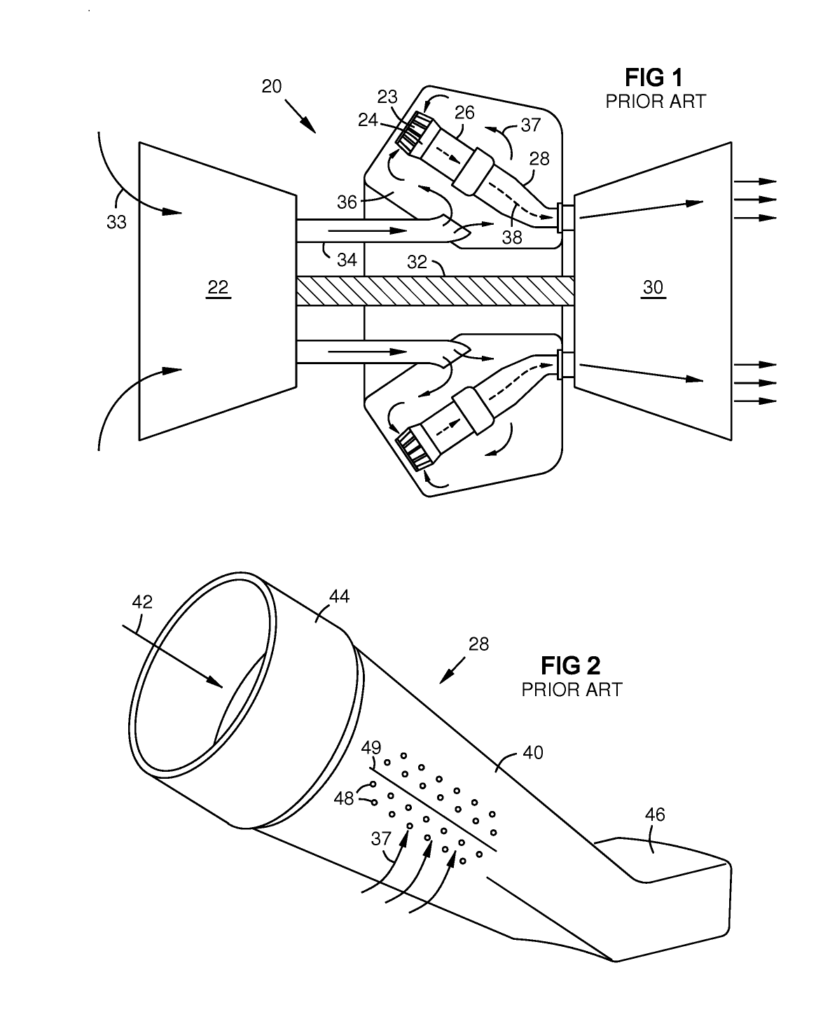

FIG. 1 is a schematic view of a prior art gas turbine engine 20 that includes a compressor 22, fuel injectors positioned within a cap assembly 24, combustion chambers 26, transition ducts 28, a turbine 30, and a shaft 32 by which the turbine 30 drives the compressor 22. Several combustor assemblies 24, 26, 28 may be arranged in a circular array in a can-annular design known in the art. During operation, the compressor 22 intakes air 33 and provides a flow of compressed air 37 to the combustor inlets 23 via a diffuser 34 and a combustor plenum 36. The fuel injectors within cap assembly 24 mix fuel with the compressed air. This mixture burns in the combustion chamber 26 producing hot combustion gasses 38 that pass through the transition duct 28 to the turbine 30. The diffuser 34 and the plenum 36 may extend annularly about the shaft 32. The compressed airflow 37 in the combustor plenum 36 has higher pressure than the working gas 38 in the combustion chamber 26 and in the transition duct 28.

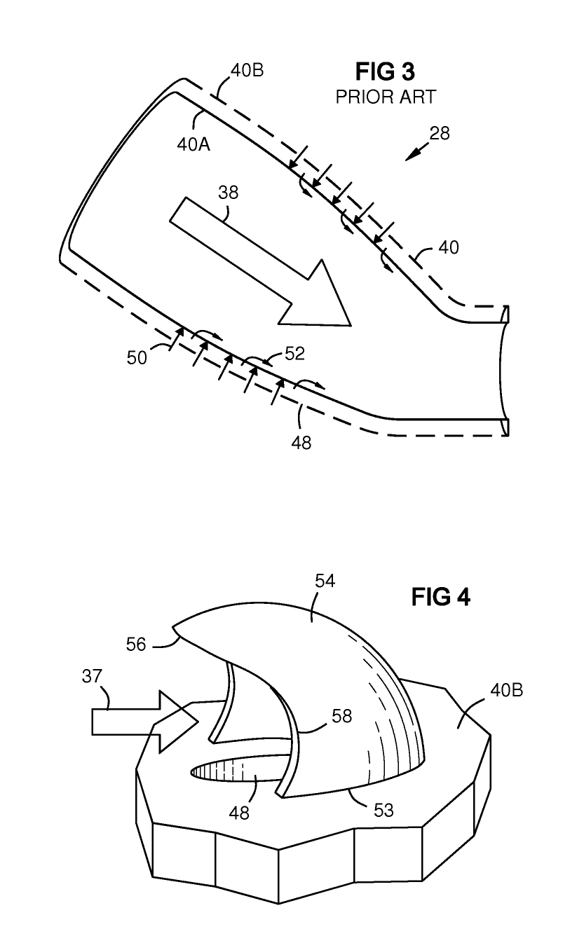

FIG. 2 is a perspective view of a prior art transition duct 28 comprising a tubular enclosure with a wall 40 bounding a hot gas path 42. The upstream end 44 may be circular and the downstream end 46 may be generally rectangular with turbine-matching curvature as shown. FIG. 3 schematically shows a sectional side view of the duct 28 illustrating that the wall 40 includes an inner wall 40A and an outer wall 40B or sleeve. The outer wall 40B may be perforated with holes 48 that admit cooling air, which forms impingement jets 50 directed against the inner wall 40A. After impingement, the coolant may pass through film cooling holes 48 in the inner wall 40A for film cooling 52 as known in the art and/or it may flow to the combustion chamber. A similar double-wall construction may be used on the combustion chamber 26 and the invention may be applied there as well. FIG. 2 also illustrates a trip strip 49 as used in the art at a location proximate a region or line of maximum constriction of the flow 37 as it passes between the duct 28 and an adjacent duct. Upstream of the region of maximum constriction the flow 37 is constricting as it moves forward because the area between the adjacent ducts is decreasing. Downstream of the region of maximum constriction between adjacent transition ducts the flow 37 is diffusing and becomes locally unstable, thereby interfering with the effectiveness of the holes 48 in the unstable flow region. The trip strip 49 is used to ensure that separation of the flow 37 occurs at a desired location.

Although the compressed airflow 37 in the combustor plenum 36 has higher pressure than the working gas 38, it is beneficial to increase this differential to increase the velocity of the impingement jets 50. This has been done using an air scoop at each of at least some of the impingement holes 48. The scoops may redirect some of the coolant flow into the holes 48. They convert some of the coolant velocity pressure to static pressure at the holes 48, thus increasing the pressure differential.

FIG. 4 shows an embodiment of an air scoop 54 per aspects of the invention. Scoop 54 may have a leading edge with a generally centralized forward projection or tongue 56 that overhangs the hole 48, and an undercut, such as curved undercut 58, on each side of the tongue between the tongue and a C-shaped or generally U-shaped attachment base 53. The leading edge shape of scoop 54 is thus streamlined for reduced aerodynamic friction and downstream turbulence. The scoop 54 may have a spherical geometry with an attachment base 53 along an equator thereof. Such geometry minimizes aerodynamic friction, especially wasted or collateral friction.

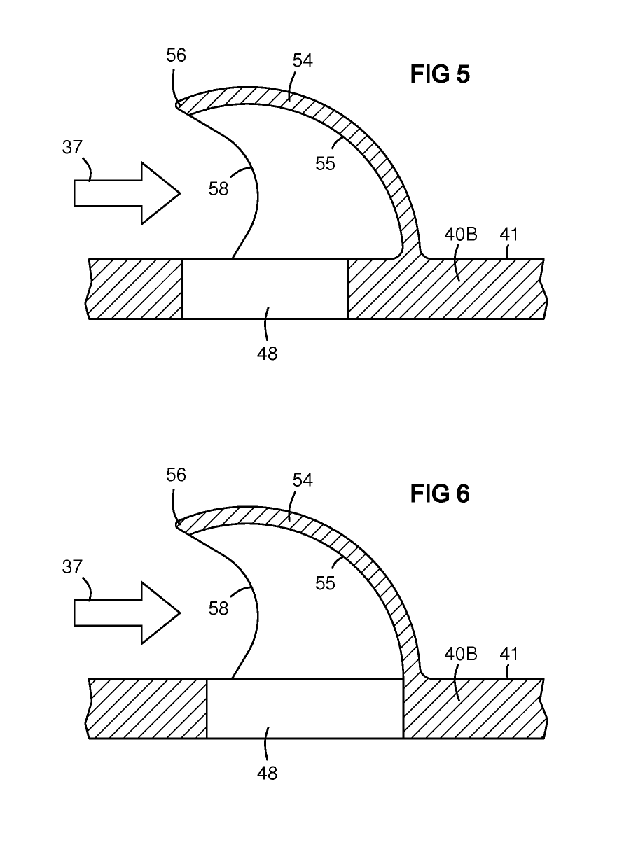

FIG. 5 is a sectional view of FIG. 4. An outer surface 41 of the wall 40B and an inner surface 55 of the scoop 54 are indicated. The leading edge 56, 58, or at least the tongue 56, may taper to a sharp leading edge portion distally for streamlining. FIG. 6 is a sectional view of a scoop 54 similar to that of FIG. 4, showing a different hole size and position of the scoop 54 relative to the hole 48. The cooling scoop 54 design herein improves the ability to redirect airflow to be used for impingement characteristics of the combustion system. In this embodiment the attachment of the inner surface of the scoop 54 is smoothly aligned with a rearmost portion of the hole 48 at the attachment base, whereas in the embodiment of FIG. 5 the attachment base is positioned somewhat behind the rearmost portion of the hole.

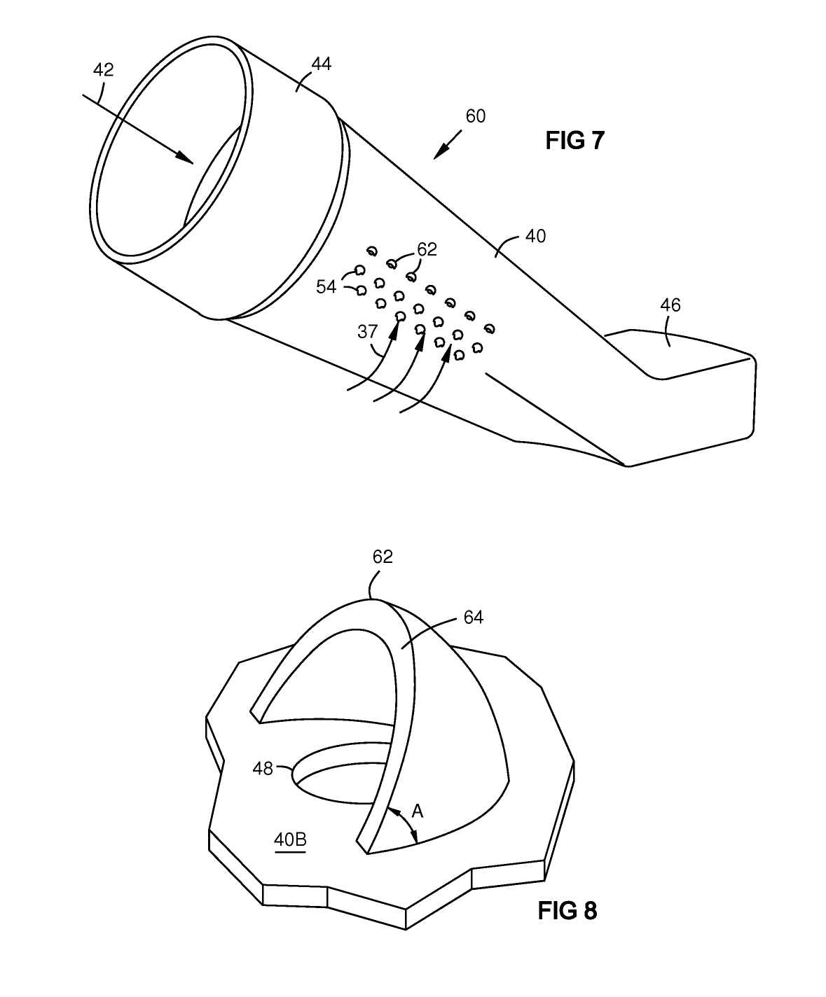

FIG. 7 is a perspective illustration of a transition duct 60 including a plurality of scoops 54 such as illustrated in FIGS. 5 and 6. In addition, the duct 60 includes a plurality of partial scoops 62. The term “partial scoop” is further illustrated in FIG. 8, which is a closer perspective view of a single partial scoop 62 disposed around a single impingement hole 48. Note that the partial scoop 62 includes a generally planar leading edge 64 lying in a plane that forms an acute angle A (less than 90 degrees) with a plane representing the local surface of the duct wall 40B (recognizing that the local surface may have a slight curvature). In the embodiment of FIG. 7, the partial scoops 62 are disposed at locations downstream of the region of maximum constriction between adjacent transition ducts (i.e. the line where a prior art trip strip would otherwise be located). The combination of scoops 54 upstream of the region of maximum constriction and partial scoops 62 downstream of that region has been found to provide adequate cooling without the need for trip strips.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A cooling apparatus that redirects a coolant fluid, comprising;
a first scoop over a first coolant inlet hole in an external wall of a gas turbine component;
the first scoop comprising a leading edge with a central tongue that overhangs the hole, and a curved undercut on each side of the tongue between the tongue and an attachment base of the scoop;
wherein the base is attached to an outer surface of the wall, and partly surrounds the first hole.

2. The cooling apparatus of claim 1, wherein the first scoop has a spherical geometry, and the base follows an equator thereof.

3. The cooling apparatus of claim 1, wherein the external wall is an outer wall of a double-walled gas turbine transition duct, wherein the coolant fluid forms impingement jets directed by the first scoop through the first hole against an inner wall of the transition duct.

4. The cooling apparatus of claim 1, wherein the tongue is tapered to a sharp leading edge portion distally.

5. The cooling apparatus of claim 1, wherein a rearmost portion of the attachment base is positioned a distance behind a rearmost portion of the hole.

6. The cooling apparatus of claim 1, further comprising a second scoop disposed over a second coolant inlet hole in the external wall of the gas turbine component, the second scoop comprising:
a C-shaped or generally U-shaped attachment base;
sides extending from the base to a generally planar leading edge;
the generally planar leading edge lying in a plane that forms an acute angle with a plane of the attachment base.

7. A cooling apparatus that redirects a coolant fluid, comprising:
a C-shaped or generally U-shaped attachment base;
curved sides extending from the base;
a central tongue extending forward from the curved sides;
the sides being undercut relative to the base on each side of the tongue between the tongue and the base to define a streamlined scoop shape.

8. The cooling apparatus of claim 7, wherein the tongue is tapered to a sharp leading edge portion distally.

9. A cooling apparatus that redirects a coolant fluid, comprising;
a transition duct wall disposed in a coolant flow in a can-annular gas turbine engine; and
a plurality scoops disposed over a respective plurality of coolant inlet holes formed in the transition duct wall at locations upstream of a region defining a minimum distance between the transition duct wall and an adjacent transition duct wall, each scoop comprising a leading edge with a central projection that overhangs the respective coolant inlet hole and an undercut on each side of the projection between the projection and a base of the scoop attached to the transition duct wall.

10. The cooling apparatus of claim 9, further comprising a plurality of partial scoops disposed over a respective plurality of coolant inlet holes formed in the transition duct wall at locations downstream of the region defining the minimum distance between the transition duct wall and the adjacent transition duct wall, each partial scoop comprising a generally planar leading edge lying in a plane that forms an acute angle with a plane of the duct wall proximate the respective hole.
